(19) United States
(12) Patent Application Publication
(10) Pub. No.: US 2008/0258341 A1
(43) Pub. Date: Oct. 23, 2008

(54) LIGHTWEIGHT SINGLE-USE CONCRETE CURING SYSTEM

(76) Inventors: Nigel Parkes, Atlanta, GA (US); Russell Boxall, Matthews, NC (US); Philip Edward Harris, High Point, NC (US); Richard James Bilton, Greensboro, NC (US)

Correspondence Address: BANNER & WITCOFF, LTD., TEN SOUTH WACKER DRIVE, SUITE 3000, CHICAGO, IL, 60606, US

(21) Appl. No.: 11/423,108

(22) Filed: Jun. 8, 2006

Related U.S. Application Data
(60) Provisional application No. 60/688,660, filed on Jun. 8, 2005.

(51) Int. Cl. D04H 1/00; B28B 1/14

(52) U.S. Cl. 264/299; 442/415

(57) ABSTRACT

A lightweight concrete curing blanket includes a layer of nonwoven fabric that is hydrophilic and that has a thickness of less than about 0.020 inches. A layer of film (e.g., polyethylene film) is bonded to the layer of nonwoven fabric, and has a thickness less than or equal to about 0.001 inch. The layer of film has a moisture vapor transport rate of less than about 0.0016 grams per square foot per twenty-four hours. A combined weight of the layer of nonwoven fabric and the layer of film is less than about 100 grams per square meter.

### CROSS-REFERENCE TO RELATED PATENT APPLICATIONS

This patent application claims priority to U.S. Provisional Patent Application No. 60/780,971, filed Jun. 8, 2005.

### FIELD OF THE INVENTION

This invention is related to concrete curing systems, such as moisture retaining blankets for concrete slabs, used to maintain suitable conditions during the hydration of concrete as it cures.

### BACKGROUND OF THE INVENTION

Concrete is prepared by mixing cement, water, and aggregate together to make a workable paste. The mixture is then typically poured into molds or forms until it hardens or “cures.” Concrete is conventionally cured in the presence of water to optimize cement hydration. Concrete strength and water-resistance improves when cement particles are thoroughly hydrated during curing. Desirable conditions for concrete curing slow the loss of moisture from the concrete and reduce the early formation of carbonation of the surface. Improper curing occurs under conditions that result in high rates of evaporation such as low humidity, high winds, and high temperatures. Reduced moisture and drying of concrete inhibits cement particle hydration, which results in reduced concrete strength. If drying is excessive, light traffic on a concrete surface may result in dusting. Moreover, craze cracking often may be attributed to inadequate curing conditions. These and other problems are common when concrete is poured in large slabs and moisture is not uniformly controlled during curing. Therefore it is desirable to maintain an amount of water on the surface of curing concrete to prevent problems such as craze cracking and dusting and to promote desired results such as the increased strength of the cured concrete.

One conventional covering material is plastic sheeting. Plastic sheeting by itself is difficult to place evenly on the surface of wet concrete. Incomplete contact between a plastic sheet and concrete surface may lead to discoloration of the concrete surface. Wrinkles and bubbles can result in non-uniform coloration, streaking or “blotchiness” on the surface of the cured concrete. Discoloration is more of a concern as the industry increases the use of pigmented and decorative concretes. Surface blotchiness may be further accentuated by plastic sheeting that is exposed to sunlight during curing.

Another means by which a concrete surface is conventionally kept wet during the curing process is by frequently applying water to the surface of the concrete and then covering the surface with a moisture retaining material. Burlap is an example of one such moisture retaining material commonly employed in the art. Burlap is placed on a newly poured concrete surface as soon the concrete is sufficiently set to avoid marking the concrete surface. The material is kept continuously wet and in place as long as possible. To ensure continuity of the moist conditions required for optimal curing, and to try to prevent intermittent drying of the material through processes such as evaporation, a plastic sheet is conventionally laid on top of the material to serve as a moisture barrier.

One product that combines a fabric and plastic sheeting is disclosed in U.S. Pat. No. 4,485,137 issued to White. White discloses a curing blanket which is designed to cover and protect concrete during curing. This blanket comprises a surface layer made from a water-impervious, low-density thermoplastic and a heavy (4 oz/yd²) batting layer made from a nonwoven hydrophobic synthetic material. According to the patent, the blanket uses the synthetic, hydrophobic fibrous batting to overcome the undesirable qualities of both burlap, and of blankets that have paper or air-laid pulp layer in contact with the wet concrete. White employs synthetic, hydrophobic fibers such as polypropylene to prevent the shedding, rotting, and other undesirable qualities of the previous blankets known in the art that use cellulose fibers. However in doing so, White abandons the desirable properties of hydrophilic and absorbent fibers that enable the water to be rapidly taken up to prevent pooling. Pooled water expressed from a synthetic hydrophobic fiber blanket as it becomes saturated can locally cause the moisture content to be too high and weaken the top surface of the concrete. This leads to dusting and cracking of the very top surface of the poured concrete slab. The use of hydrophilic fibers, and more preferably, absorbent fibers in the layer in contact with the curing concrete, controls the moisture content more uniformly, reduces pooling, and maintains a high humidity environment, which keeps the concrete surface from drying out from evaporation, optimizing the conditions for curing.

While White uses only hydrophobic fibers, other products seek to incorporate cellulose for its absorptive qualities. One such product is disclosed in the application published by McDonald, U.S. Pat. Appl. No 2005/0042957. McDonald discloses a concrete curing blanket that incorporates an air-laid pulp made from short wood pulp fibers that are loosely bonded into the structure. Although, the design described in McDonald uses cellulose for its hydrophilic nature and absorption qualities, the structure of the product is such that when wetted, cellulose may break down and slough off from the fabric matrix, resulting in fibers in the dried concrete. Having fibers in the dried concrete is undesirable and difficult to clean up.

### SUMMARY OF THE INVENTION

The design of this invention solves both problems in that the hydrophilic and more preferably absorbent fibers are entangled or bonded into a thinner, more consolidated fabric matrix that gives both superior wicking, absorbent and control of humidity and moisture levels in the microenvironment above wet, curing concrete. The design of this invention provides for a thinner product, which both reduces the space between the curing concrete and the impermeable barrier and results in a product that more completely contacts the surface of the curing concrete. The thinner product results in a reduced volume above the curing concrete, creating a smaller microenvironment in which moisture and humidity can equilibrate. Additionally there is no sloughing or fiber deposition from the fabric matrix. There is no degradation of the fibers of the invention as opposed to those in which natural cellulose is used in the fabric. As the fabric and backing is thinner, the product is lighter in weight and easier and more efficient to place on the curing concrete. The lightweight blanket is also easier to remove and cleanup, and is more environmentally friendly.

### DETAILED DESCRIPTION OF THE INVENTION

Embodiments of the present invention provide a two-layered concrete curing blanket having a nonwoven fabric layer and a thermoplastic film layer laminated together by any suitable means, such as an adhesive.

The first layer of the blanket is the film or backing. The film layer serves as a moisture barrier that substantially prevents evaporation of moisture from the concrete surface. While polyethylene is a preferred polymer component of the film layer, any polyolefin, polyester, copolyester, nylon, urethane, or other thermoplastic polymer may also be used to form the film layer. Bicomponent or multilayer films such as black/white agricultural film, metallized film, highly filled films and films in a variety of colors may be used in response to environmental conditions that require more or less solar reflectivity or more or less infrared absorption as needed. For example, areas with greater heat and sunshine may require a reflective film (e.g. a film with a light color, such as white, silver, etc,), while colder areas may need a darker film to absorb and retain heat. According to some embodiments of the present invention, the layer of film may have one or more portions with a light reflective color that reflects sunlight and/or one or more portions with a light absorptive color that absorbs sunlight and retains heat therefrom.

The film layer is relatively thin to reduce the overall weight of the product. According to some embodiments of the present invention, the film layer has a thickness of 1 mil (0.001 inch), which is less than conventional film layers used in covering concrete. Conventional film layers typically have a thickness of 3 mil and higher. Although thinner than conventional films used in concrete curing blankets, the film layer is configured to prevent evaporation of water absorbed by the nonwoven fabric layer over a seven day curing period. According to embodiments of the present invention, the film layer has low moisture permeability (i.e., moisture vapor transport is less than about 0.0016 grams per square foot per 24 hours). According to some embodiments, the film layer has a weight of about 0.72 ounce/square yard. While embodiments of the invention employ a film backing that is 1 mil in thickness, films with thicknesses of up to 2, 3, 4, 5 mil or more may alternatively be used to increase handling ability and other characteristics of the blanket.

The nonwoven fabric layer is in contact with the surface of the curing concrete as the invention is used. The nonwoven fabric layer is hydrophilic, and more preferably absorbent, and serves as a moisture absorbent layer. The nonwoven fabric layer provides a wicking effect that distributes excess water from locations under the blanket and results in a uniform level of moisture and humidity in the space above the curing concrete. In addition to being highly wickable and absorbent, the nonwoven fabric layer is thin, as compared to conventional concrete blankets, which helps keep moisture as close to the concrete surface as possible, thus facilitating maintaining an equal moisture level in the uppermost surface of the concrete. According to some embodiments of the present invention, the nonwoven fabric layer is a spunlaced blend of fibers. Additionally, the nonwoven fabric may be bonded by resin bonding, powder bonding, thermal bonding, needlepunching, or stitchbonding.

Applicants have found that a thin nonwoven fabric layer as described herein can maintain an even moisture level better than a layer of material three to four times in thickness. According to some embodiments of the present invention, the nonwoven fabric layer has a thickness of less than about 0.02 inches, which is much less than conventional wicking layers that typically have thicknesses of 0.080 inches and higher. Moreover, the nonwoven fabric layer is capable of wicking moisture from low areas of a concrete surface to higher areas, thereby keeping the moisture content uniform.

According to some embodiments of the present invention, the nonwoven fabric layer is a spunlaced blend of polyester, rayon, and lyocell (e.g., Tencel® brand lyocell, from Courtaulds Fibres (Holdings) Limited, United Kingdom). The relative proportions of the fibers are from about 10% to about 100% cellulosic fibers, either rayon or lyocell, or blends thereof, and up to 90% polyester. However, these proportions may be somewhat lower or substantially higher, without limitation. Generally, the polyester component provides strength and the rayon component provides absorbency. Other components may be added according to intended uses of the concrete curing blanket. Spunlacing produces a soft, thin, strong and intimate blend of the polyester, rayon and lyocell which is optimum for absorbing sufficient water to stay moist over a 7 day curing period, to spread the amount of water very evenly over the entire concrete surface, and to keep the moisture very close to the concrete surface.

According to embodiments of the present invention, the nonwoven fabric layer has a thickness of less than about 0.05 inches, which is much less than conventional wicking layers that typically have thicknesses of 0.080 inches and higher. In addition, the nonwoven fabric layer is lightweight compared with conventional wicking layers. According to some embodiments of the present invention, the nonwoven fabric layer may have a weight of less than about 55 grams per square meter (g/m²). According to some embodiments of the present invention, the nonwoven fabric layer may have a weight of less than about 70 g/m². According to embodiments of the present invention, the nonwoven fabric layer has a weight of less than about 100 g/m², which is much less than conventional wicking layers having a weight of approximately 150 g/m² and higher.

According to embodiments of the present invention, the nonwoven fabric layer may be spunlaced and is a blend of polyester, rayon, and lyocell. The relative proportions of the components of the nonwoven fabric layer, according to embodiments of the present invention, are about 30% rayon and at least about 30% polyester. These proportions may be somewhat lower or higher. Moreover, other materials may be used in lieu of these components. The remaining portion of a nonwoven fabric layer, according to embodiments of the present invention, may be polyester, rayon, lyocell or other generic rayon fibers with similar base chemistry (such as viscose). Generally, the polyester component provides strength and the rayon component provides absorbency. In addition, the polyester layer may be copolyester binder fiber, bicomponent fiber, or polypropylene fiber that could enable on-site thermal bonding of the blanket edges. Other components may be added according to intended uses of the concrete curing blanket.

Concrete curing blankets according to embodiments of the present invention are distinguishable from conventional curing blankets containing conventional absorbing materials, such as cellulose air laid, or paper. Conventional absorbent layers can break down due to exposure to the high pH environment and ultraviolet radiation during curing and may require additional clean up of fibrous material, which can be labor intensive and can increase costs.

Adhesives used to laminate the nonwoven fabric layer and polyethylene film layer, according to embodiments of the present invention, may be ultraviolet durable adhesives. Ultraviolet durable adhesives are those that maintain their adhesive strength when exposed to ultraviolet radiation for periods of 100 hours without a significant loss of strength. Preferably, the adhesive will maintain at least 75% of its initial strength when exposed to ultraviolet radiation for 100 hours. Even more preferably, the adhesive will maintain at least 95% of its initial strength when exposed to ultraviolet radiation for 100 hours. Alternatively, lower cost pressure sensitive adhesives may be utilized.

Concrete curing blankets according to embodiments of the present invention can significantly improve the evenness of finished concrete color. This is because blotches that are caused by uneven moisture during curing are eliminated. In addition, concrete surfaces cured using blankets according to embodiments of the present invention may have improved gloss. In addition, concrete curing blankets according to embodiments of the present invention may be significantly lighter than conventional covering materials which can improve handling, installation and removal.

Two grades of polyester/rayon concrete curing blankets are described in the following examples. However, numerous combinations of materials may be used without limitation.

### EXAMPLE 1

### Lightweight Concrete Curing Blanket Materials

| Component | Material |
|---|---|
| Fabric | Nominal 55 g/m² spunlace nonwoven blend |
| | Approximate fiber blend 50% polyester, 50% generic rayon |
| | (both rayon and Tencel lyocell) |
| Film | Nominal 1 mil (0.72 oz/yd²) low density polyethylene, cast |
| | embossed white film |
| Adhesive | Approximately 0.175 oz/yd² S-EB-S type |

### EXAMPLE 2

### Heavyweight Concrete Curing Blanket Materials

| Component | Material |
|---|---|
| Fabric | Nominal 70 g/m² spunlace nonwoven blend |
| | Approximate fiber blend 30% polyester, 70% generic rayon |
| | (this construction has Tencel lyocell) |
| Film | Nominal 1 mil (0.72 oz/yd²) low density polyethylene, cast |
| | embossed white film |
| Adhesive | Approximately 0.175 oz/yd² S-EB-S type |

Use of a concrete curing blanket according to embodiments of the present invention is described. After concrete has been poured, it is finished and allowed to partially dry. At this point (after approximately 1 day) the concrete is hard to the touch and can be walked on. The concrete surface is then flooded with water and a concrete curing blanket, according to embodiments of the present invention, is applied on top of the water layer. The concrete is then left for approximately 7 days to final cure. Upon removal of the blanket, the cured concrete has the correct moisture content and the surface is uniformly colored.

The foregoing is illustrative of the present invention and is not to be construed as limiting thereof. Although a few exemplary embodiments of this invention have been described and several examples provided, those skilled in the art will readily appreciate that many modifications are possible in the exemplary embodiments without materially departing from the novel teachings and advantages of this invention.

Variations and modifications of the foregoing are within the scope of the present invention. It should be understood that the invention disclosed and defined herein extends to the individual features and all alternative combinations of two or more of the individual features mentioned or evident from the text and/or drawings. All of these different combinations constitute various alternative aspects of the present invention. The embodiments described herein comprise modes known for practicing the invention and will enable others skilled in the art to utilize the invention. The claims are to be construed to include alternative embodiments to the extent permitted by the prior art. The invention is therefore limited only by the following claims and equivalents thereof.

What is claimed is:

1. A concrete curing system comprising:
a film backing layer having a first surface and a second surface, the film backing being a thermoplastic impermeable to moisture;
a nonwoven fabric layer, said fabric comprised of a mixture of polyester and rayon fibers, said fabric having a first surface and a second surface;
an adhesive securing the second surface of the film backing layer to the first surface of the fabric layer.

2. The concrete curing system as in claim 1 wherein said film backing comprises low density polyethylene.

3. The concrete curing system as in claim 1, wherein said film backing is less than 2 mils in thickness.

4. The concrete curing system as in claim 1, wherein said film backing is white.

5. The concrete curing system as in claim 1, wherein said film backing is colored.

6. The concrete curing system as in claim 1 wherein said the fabric is comprised of a mixture of polyester and rayon.

7. The concrete curing system as in claim 6 wherein composition of the fabric is a spunlaced blend of at least 30% polyester and at least 30% rayon.

8. The concrete curing system as in claim 1 wherein composition of the fabric is a spunlaced blend of polyester, rayon and lyocell.

9. The concrete curing system as in claim 8 wherein composition of the fabric is a spunlaced blend of up to 90% polyester and at least about 10% to about 100% cellulosic fibers, said cellulosic fiber selected from rayon and lyocell, and mixtures thereof.

10. The concrete curing system as in claim 4, wherein the weight of the fabric is between about 55 grams per square meter and about 70 grams per square meter.

11. The concrete curing system as in claim 1 wherein said adhesive is resistant to degradation by ultraviolet light.

12. A concrete curing system comprising:
a polyethylene film backing impermeable to moisture having a first surface and a second surface and a thickness of less than 3 mils;
a spunlaced, needlepunched or carded nonwoven polyethylene and rayon fabric, said fabric comprised of a mixture of at least 30% polyester fibers and at least 30% rayon fibers, said fabric having a first surface and a second surface;
an ultraviolet light stabile adhesive securing the film backing to the fabric.

12. A concrete curing blanket, comprising:
a layer of nonwoven fabric, wherein the layer of nonwoven fabric comprises polyester, rayon, and lyocell, and wherein the layer of nonwoven fabric has a thickness of less than about 0.050 inches; and
a layer of film laminated to the layer of nonwoven fabric, wherein the layer of film has a thickness less than about 0.003 inch.

13. The concrete curing blanket of claim 12, wherein the layer of film comprises polyethylene film.

14. The concrete curing blanket of claim 12, wherein the layer of film has a moisture vapor transport rate of less than about 5 grams per square foot per twenty-four hours.

15. The concrete curing blanket of claim 12, wherein the layer of nonwoven fabric has a thickness of less than about 0.05 inches.

16. The concrete curing blanket of claim 12, wherein a combined weight of the layer of nonwoven fabric and the layer of film is less than about 100 grams per square meter.

17. A method of curing concrete, comprising:
pouring a slab of concrete, wherein the concrete slab has an exposed surface;
flooding the concrete surface with water;
covering the concrete surface and water on the surface with a concrete curing blanket, wherein the concrete curing blanket comprises:
a layer of nonwoven fabric, wherein the layer of nonwoven fabric comprises rayon, and lyocell, and wherein the layer of nonwoven fabric has a thickness of less than about 0.050 inches; and
a layer of film laminated to the layer of nonwoven fabric, wherein the layer of film has a thickness less than about 0.003 inch; and
allowing the concrete to cure for a predetermined period of time.

18. The method of claim 17, wherein the layer of film comprises polyethylene film.

19. The method of claim 17, wherein the layer of film has a moisture vapor transport rate of less than about 1.0 grams per square foot per twenty-four hours.

20. The method of claim 17, wherein the layer of nonwoven fabric has a thickness of less than about 0.020 inches.
